(19) United States
(12) Patent Application Publication
(10) Pub. No.: US 2025/0315900 A1
(43) Pub. Date: Oct. 9, 2025

(54) AUTOMATED TAX SAVINGS METHODS AND SYSTEMS

(71) Applicant: The Augusta Rule, LLC, Moscow, ID (US)

(72) Inventor: Nethaniel Ealy, Moscow, ID (US)

(73) Assignee: The Augusta Rule, LLC, Moscow, ID (US)

(21) Appl. No.: 19/021,121

(22) Filed: Jan. 14, 2025

Related U.S. Application Data
(60) Provisional application No. 63/631,981, filed on Apr. 9, 2024.

(51) Int. Cl. G06Q 40/10; G06Q 40/12

(52) U.S. Cl. CPC G06Q 40/10; G06Q 40/123

(57) ABSTRACT

The present invention provides a method for handling a tax service by an electronic device. The method includes receiving a user input including an entity type, a rental rate, a number of rental events intended by the user and a tax status, while applying the Augusta Rule for the tax service. The method includes obtaining a database including a rental rate data sourced from a third-party provider, and obtaining an event based on the user input. The method includes identifying and presenting a plurality of high priority dates to the user based on the event. The method further includes selecting a high priority date from the plurality of high priority dates to rent a property, and generating a rental value for high priority date based on a predefined rental rate for the property within a user-defined region, wherein the at least one generated rental value estimates a tax saving information.

### CLAIM OF PRIORITY, IDENTIFICATION OF RELATED APPLICATIONS

This Non-Provisional Patent application claims priority from U.S. Provisional Patent Application No. 63/631,981 filed on Apr. 9, 2024 entitled AUTOMATED REAL ESTATE TAX SAVINGS METHODS AND SYSTEMS, to common inventors Nethaniel Ealy.

### TECHNICAL FIELD

The present invention generally relates to automated tax services, and more specifically relates to a method and an electronic device for handling a tax service.

### Problem Statement and History

### Interpretation Considerations

This section describes technical field in detail and discusses problems encountered in the technical field. Therefore, statements in the section are not to be construed as prior art.

### Discussion of History of the Problem

Individuals and businesses face significant challenges in comprehending and applying the Augusta Rule due to its inherent complexities and the nuanced tax implications associated with it. A widespread lack of understanding leads to common mistakes in its implementation, such as incorrect reporting of rental days, miscalculation of fair rental price, and misinterpretation of eligible properties. Consequently, the potential tax benefits are frequently underutilized, or the Augusta Rule is simply ignored by taxpayers, costing them thousands of dollars.

In addition, substantial time investment is required to ensure compliance with the Augusta Rule. Taxpayers and advisors must navigate through a labyrinth of Internal Revenue Service (IRS) forms and instructions, which often result in excessive hours spent in preparation and consultation to avoid the repercussions of non-compliance, such as audits and penalties. This not only places a strain on resources but also deters many from leveraging the Augusta rule altogether.

Moreover, the complexity of IRS forms pertinent to the Augusta Rule, such as Schedule E and the 1099-MISC, further exacerbated the issue. The task of accurately completing these forms demands a high level of tax competence, which many individuals and small businesses lack. This deficiency leads to errors in filings and the underreporting or overreporting of income, culminating in missed opportunities for tax optimization. Also, misfiled forms risk audits. The taxpayers know this and often choose to just not bother using the Augusta Rule to their advantage.

In essence, the landscape of the Augusta Rule is fraught with confusion, inefficiency, and a high risk of costly mistakes, calling for an innovative solution to streamline the process and clarify its application. Accordingly, the present invention provides such a solution.

### SUMMARY

The above objective is achieved by a method and an electronic device for handling a tax service as disclosed herein.

The method includes signing up, by a user, on the electronic device. During the signup, the user provides a name, an address, a location information, a property type, a previous user feedback, and contact details. Further, the method includes receiving, by the electronic device, a user input including at least one entity type, at least one rental rate, a number of rental events intended by the user and at least one tax status, while applying an Augusta Rule for the tax service. The user input is received after the signup by the user. Further, the method includes obtaining, by the electronic device, one or more database(s) including a rental rate data sourced from a third-party provider, and obtaining, by the electronic device, one or more event(s) based on the user input. The one or more event(s) includes a calendar event, a historical event, a sports event, a government related event, a musical event, a movie related event, and a traveling event. Further, the method includes identifying and presenting, by the electronic device, a plurality of high priority dates to the user based on the one or more event(s), and selecting, by the electronic device, one or more high priority date(s) from the plurality of high priority dates to rent a property by comparing the one or more high priority date(s) among the plurality of high priority dates. Further, the method includes generating, by the electronic device, one or more rental value(s) for one or more high priority date(s) based on a predefined rental rate for the property within a user-defined region. The rental value is generated in accordance with an Internal Revenue Service (IRS) guideline. The predefined rental rate is computed based on the rental rate data sourced from the third-party provider and the one or more event(s). The predefined rental rate is determined by at least one of: the user, a service provider and a government agency. Further, the method includes allowing, by the electronic device, an entry to adjust the one or more generated rental value(s). The one or more generated rental value(s) estimates a tax saving information. Further, the method includes generating, by the electronic device, a tax related document including the one or more generated rental value(s) and the tax saving information. The tax related document includes one or more invoice(s) and a predefined form at an end of a year reflecting income received from one or more rental event. Further, the method includes validating, by the electronic device, the tax related document, and storing, by the electronic device, the tax related document for one or more audit purpose(s).

In an embodiment of the present invention, the method includes generating, by the electronic device, a property score for the one or more audit purpose(s). The property score is generated by: at least one of: at least one evidence supporting an existence of the one or more event(s), rental information and a feedback from a customer.

In an embodiment of the present invention, allowing, by the electronic device, the entry to adjust the one or more generated rental value(s) includes obtaining, by the electronic device, one or more date(s) of one or more future event(s), obtaining, by the electronic device, at least one of: a feedback and a notification about the one or more date(s) of the one or more future event(s) from the third-party provider, and allowing, by the electronic device, the entry to adjust the one or more generated rental value(s) based on at least one of: the feedback and the notification.

In an embodiment of the present invention, the method includes sending, by the electronic device, a reminder and a notification to the user to perform one or more tax-related action(s).

In an embodiment of the present invention, the method includes securing, by the electronic device, the validated tax related document in an event of the one or more audit purpose(s).

In an embodiment of the present invention, the method includes receiving, by the electronic device, a feedback about the validated tax related document and the tax service.

In an embodiment of the present invention, the electronic device teaches the user about the Augusta Rule and guide the user through a process of maximizing benefits and minimizing liabilities. The electronic device allows multiple residences per account of the user.

Of course, the present is simply a summary, and not a complete description of the invention.

### BRIEF DESCRIPTION OF THE DRAWINGS

Various aspects of the invention and its embodiment are better understood by referring to the following detailed description. To understand the invention, the detailed description should be read in conjunction with the drawings.

FIG. 1 illustrates a tax savings system.

FIG. 2 illustrates various hardware elements of a tax service handling controller of the tax savings system.

FIG. 3 illustrates a flow chart of a method for handling the tax service.

FIG. 4 is an example screenshot showing business set-up information panel.

FIG. 5 is an example screenshot showing rent computation from a third-party source.

FIG. 6 is an example screenshot displaying a rental event creation.

FIG. 7 is an example screenshot showing a defendability score.

FIG. 8 is an example screenshot of a client profile.

FIG. 9 is an example screenshot showing a summary associated with the client profile.

FIG. 10 is an example screenshot showing events associated with the client profile.

FIG. 11 is an example screenshot of a client profile setting panel.

FIG. 12 is an example screenshot for updating profile information such as rental information and address information associated with the client profile.

FIG. 13 is an example screenshot of an event filing panel.

FIG. 14 is an example screenshot of a review tax and saving calculation panel.

FIG. 15 is an example screenshot of the review tax and saving calculation panel in conjunction with FIG. 14.

FIG. 16 is an example screenshot displaying tax service-related notification.

FIG. 17 is an example screenshot displaying tax service-related educational videos.

### DESCRIPTION OF AN EXEMPLARY PREFERRED EMBODIMENT Interpretation Considerations

While reading this section (Description of An Exemplary Preferred Embodiment, which describes the exemplary embodiment of the best mode of the invention, hereinafter referred to as “exemplary embodiment”), one should consider the exemplary embodiment as the best mode for practicing the invention during filing of the patent in accordance with the inventor's belief. As a person with ordinary skills in the art may recognize substantially equivalent structures or substantially equivalent acts to achieve the same results in the same manner, or in a dissimilar manner, the exemplary embodiment should not be interpreted as limiting the invention to one embodiment.

The discussion of a species (or a specific item) invokes the genus (the class of items) to which the species belongs as well as related species in this genus. Similarly, the recitation of a genus invokes the species known in the art. Furthermore, as technology develops, numerous additional alternatives to achieve an aspect of the invention may arise. Such advances are incorporated within their respective genus and should be recognized as being functionally equivalent or structurally equivalent to the aspect shown or described.

A function or an act should be interpreted as incorporating all modes of performing the function or act, unless otherwise explicitly stated. For instance, sheet drying may be performed through dry or wet heat application, or by using microwaves. Therefore, the use of the word “paper drying” invokes “dry heating” or “wet heating” and all other modes of this word and similar words such as “pressure heating”.

Unless explicitly stated otherwise, conjunctive words (such as “or”, “and”, “including”, or “comprising”) should be interpreted in the inclusive and not the exclusive sense.

As will be understood by those of the ordinary skill in the art, various structures and devices are depicted in the block diagram to not obscure the invention. In the following discussion, acts with similar names are performed in similar manners, unless otherwise stated.

The foregoing discussions and definitions are provided for clarification purposes and are not limiting. Words and phrases are to be accorded their ordinary, plain meaning, unless indicated otherwise.

### DESCRIPTION OF THE DRAWINGS, A PREFERRED EMBODIMENT

The present invention relates to a digital platform (hereinafter referred to as “tax savings system”) specifically designed to facilitate an application and management of the Augusta Rule for tax purposes by individuals and businesses. The tax savings system serves as a comprehensive solution to address the complexities associated with the manual application of the Augusta Rule, thereby simplifying the process and minimizing the potential for user error.

In other words, the present invention relates to a method and a system that facilitate tax compliance and management for the businesses in relation to the Augusta Rule, while reducing errors, and saving time. The method and system provide an efficient and compliant approach for applying the Augusta Rule for taxation. The method and system offer a comprehensive solution to the challenges individuals and businesses face when attempting to apply the Augusta Rule, hence simplifying the process, ensuring compliance, and potentially optimizing tax savings. The tax savings system educates a user on maximizing benefits, and aids in audit defense, all through an integrated digital platform.

Below is the list of reference numerals used in the patent disclosure:

| Reference | |
|---|---|
| Numeral | Element Name |
| 100 | Tax savings system |
| 110 | Service provider |
| 112 | Service provider user interface |
| 120 | Agent/Attorney |
| 122 | Agent user interface |
| 130 | Client |
| 132 | Client user interface |
| 140 | Admin |
| 142 | Admin user interface |
| 150 | Electronic device |
| 152 | Display |
| 161 | Processor |
| 163 | Memory |
| 165 | Communication unit |
| 167 | Tax service handling controller |
| 170 | Server |
| 205 | Receiving unit |
| 210 | Obtaining unit |
| 215 | Identification unit |
| 220 | Selecting unit |
| 225 | Generating unit |
| 230 | Validating unit |
| 235 | Sending unit |
| 240 | Securing unit |
| 300 | Flow chart of a method for handling a tax service |
| 400 | Screen shot showing business set-up information panel |
| 410 | Business set-up information panel |
| 500 | Screen shot showing rent computation from a third-party |
| | source |
| 510 | Rent determination panel from the third-party source |
| 600 | Screen shot displaying a rental event creation |
| 610 | Rental event creation panel |
| 700 | Screen shot showing defendability score |
| 710 | Defendability score panel |
| 800 | Screen shot of an example client profile |
| 810 | Client profile panel for residence |
| 900 | Screen shot of summary of client profile |
| 910 | Summary of a client profile |
| 1000 | Screen shot showing events for the client profile |
| 1010 | Events for the client profile |
| 1100 | Screen shot of a client profile setting panel |
| 1110 | Client profile setting panel |
| 1200 | Screen shot for updating rental information associated with |
| | the client profile |
| 1210 | Rental information associated with the client profile panel |
| 1300 | Screen shot of an event filing panel |
| 1310 | Event filing panel |
| 1400 | Screen shot of a review tax and saving calculation panel |
| 1410 | Review tax and saving calculation panel |
| 1500 | Screen shot of the review tax and saving calculation panel |
| 1510 | Review tax and saving calculation panel |
| 1600 | Screen shot displaying tax service-related notification |
| 1610 | Tax service-related notification panel |
| 1700 | Screen shot displaying tax service-related educational |
| | videos |
| 1710 | Tax service-related educational videos |

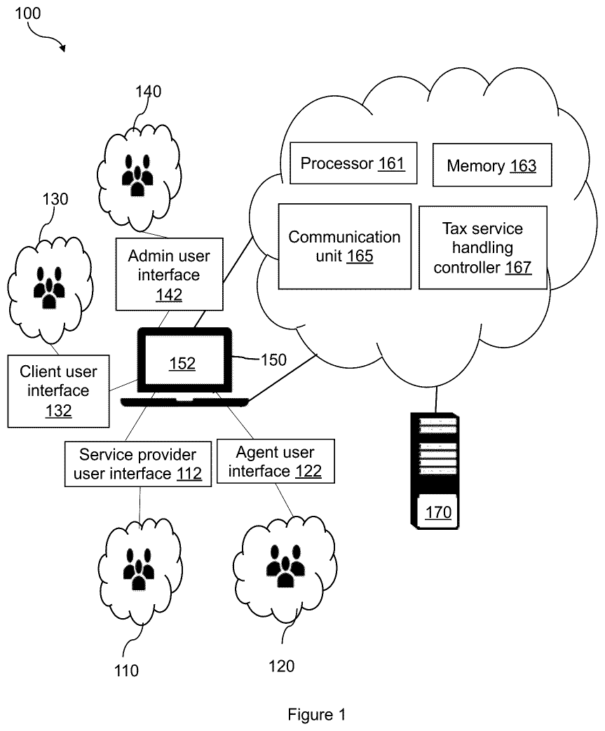

FIG. 1 illustrates a tax savings system 100 (e.g. real estate tax savings system or the like). The tax savings system 100 is, but not limited to, a cloud-based system. The tax savings system 100 may comprise subsystems, hardware, distributed computing, software, entity interfaces, and user interfaces which enable and deliver the services/functions of the present invention as described herein.

The tax savings system 100 generally comprises an electronic device 150 and a server 170. The electronic device 150 can be, for example, but not limited to a laptop, a notebook, a desktop computer, a vehicle to everything (V2X) device, a smartphone, a tablet, an internet of things (IoT) device, a television with communication facility, an immersive device, a virtual reality device, a pager or any other computing device including similar hardened and field-specific devices. The server 170 can be, for example, but not limited to a cloud server, an edge server, a web server, a virtual server, an application server, a database server or the like.

The electronic device 150 includes a display 152, a processor 161, a storage/memory 163, a communication unit 165, a tax service handling controller 167, and a plurality of user interfaces like a service provider user interface 112, an agent user interface 122, a client user interface 132, and an admin user interface 142 (for example) for a plurality of users like a service provider 110, an agent/attorney 120, a client 130, and an admin 140 respectively. Each of the plurality of users 110, 120, 130, 140 can access the tax service handling controller 167 using their respective user interfaces 112, 122, 132, 142.

Now referring to the plurality of user interfaces 112, 122, 132, 142 and the plurality of users 110, 120, 130, 140. The service provider 110, the agent/attorney 120 and the client 130 through the service provider user interface 112, the agent user interface 122, and the client user interface 132 respectively, operate, maintain and manage the tax service handling controller 167. Similarly, the admin 140 through the admin user interface 142 interacts with the tax service handling controller 167 to operate, maintain, manage and upgrade the tax service handling controller 167.

The tax service handling controller 167 acts as a core element of the tax savings system 100. The tax service handling controller 167 is configured to be accessed by the plurality of users 110, 120, 130, 140, as mentioned above, in the tax savings system 100 for handling a tax service. The tax service handling controller 167 also acts as a forecasting tool for determining the tax. Advantageously, the tax service handling controller 167 saves time as compared to existing tax service handling tools and techniques.

The user (e.g., client 130) signs up in the tax service handling controller 167 on the electronic device 150. During the signup, the user provides a name, an address, a location information, a property type, a previous user feedback (e.g., feedback related to issues with implementing the Augusta Rule in the past), and contact details.

Once signed up by the user, the tax service handling controller 167 receives a user input including an entity type (e.g., S-Corp, C-Corp, Partnership, LLC with “S” election, sole proprietorship, single-member LLC, or similar), a rental rate, a number of rental events intended by the user and a tax status (e.g., filed, yet to filed or the like), while applying the Augusta Rule for the tax service. The Augusta Rule is a tax strategy outlined under Section 280a of the IRS tax code. The Augusta Rule allows the user to rent out their primary residence or vacation home to others for up to 14 days each year.

Further, the tax service handling controller 167 obtains a database including a rental rate data sourced from a third-party provider (e.g., Airbnb®, Vacasa or the like).

In an example, the tax service handling controller 167 navigates the user to a calendar, and manages the retrieval and processing of rental rate data for tax purposes. The tax service handling controller 167 specifically interfaces with a database (not shown) that stores the rental rates sourced from various third-party providers such as Airbnb®, Vacasa or the like. Its primary function is to handle incoming requests to access this data, ensuring that the users can obtain accurate rental rates needed for tax calculations.

Key responsibilities of the tax service handling controller 167 include querying the database for the latest rental rates, handling potential errors during the data retrieval, and returning the data in a structured format (typically JSON (for example)) for easy consumption by the client. By leveraging the third-party data, the tax service handling controller 167 enhances the application's capability to provide the users with reliable and up-to-date information.

Further, the tax service handling controller 167 obtains an event based on the user input. The event can be, for example, but not limited to a calendar event, a historical event, a sports event, a government related event, a musical event, a movie related event, a state fair, concert, an inauguration event, and a traveling event (e.g., Federation Internationale de Football Association (FIFA) World Cup, Olympics, National Collegiate Athletic Association (NCAA) Finals, etc). In short, the tax service handling controller 167 pulls a historical data from the third-party provider. The tax service handling controller 167 checks the historical data to identify a rent-impact event (such as a sports game, state fair, concert, inauguration, or similar event) to determine whether the historical data is a calendar dependent or an event dependent. In another embodiment, the tax service handling controller 167 gathers dates of futures events similar to an impactful historical event. Further, the tax service handling controller 167 identifies traveling events that occur in other locations, and presents an estimated future residential rental value as a function of the impact that traveling event having at least one historical geography.

Further, the tax service handling controller 167 identifies and presents a plurality of high priority dates to the user based on the event. The tax service handling controller 167 selects one or more high priority date(s) from the plurality of high priority dates to rent a property by comparing the one or more high priority date(s) among the plurality of high priority dates. Further, the tax service handling controller 167 generates a rental value for the one or more high priority date(s) based on a predefined rental rate for the property within a user-defined region. The rental value is generated in accordance with the IRS guidelines. The predefined rental rate is computed based on the rental rate data sourced from the third-party provider and the event. The predefined rental rate is determined by at least one of: the user, a service provider and a government agency. The predefined rental rate is a fixed rate or a variable rate determined by at least one of: the user, the service provider and the government agency.

In short, the tax service handling controller 167 is a crucial part of an application designed to manage rental transactions, specifically by identifying and presenting the high-priority dates for the users based on specific events. The tax service handling controller 167 processes the input related to upcoming events and utilizes predefined criteria to highlight dates that are of significant interest for property rentals.

Once the tax service handling controller 167 identifies the set of high-priority dates, the tax service handling controller 167 further analyses these dates to select the most relevant ones for renting the property. This involves comparing the dates against the predefined criteria to ensure that the chosen dates align with user preferences and event schedules. After selecting the high-priority dates, the tax service handling controller 167 computes a rental value based on established rental rates for the property within a specified region. This functionality ensures that users receive accurate rental estimates for the most relevant dates, facilitating informed decision-making when renting properties for the events.

In an example, the tax service handling controller 167 would begin by receiving the input regarding the upcoming event, such as a concert or a conference. Using this event information, the tax service handling controller 167 queries the database to identify potential high-priority dates (i.e., dates that coincide with the event and are in high demand for rentals). For instance, if the event is scheduled for March 16, the tax service handling controller 167 might highlight March 16 through March 20 as high-priority dates due to expected demand.

Next, the tax service handling controller 167 evaluates these high-priority dates to select one or more dates that best suit the user's rental needs. This selection process might involve comparing factors such as availability, pricing, and user preferences. Once the high-priority dates are determined, the tax service handling controller 167 generates the rental value for each selected date. This calculation is based on predefined rental rates stored in the database, adjusted for the specified user-defined region.

For example, if the rental rate for a property is set at $200 per day, the tax service handling controller 167 would compute the total rental cost based on the selected high-priority dates, such as March 16 through March 20, resulting in the rental value of $1000.

Finally, the tax service handling controller 167 presents this information to the user, allowing them to review the selected dates and associated rental values, thus facilitating a seamless rental experience tailored to their specific event needs. This efficient handling of the high-priority dates and rental calculations not only streamlines the rental process but also enhances user satisfaction by providing timely and relevant information.

Further, the tax service handling controller 167 allows an entry to adjust the generated rental value by obtaining the date of one or more future event(s),a feedback and a notification about the date of the one or more future event(s) from the third-party provider. The generated rental value estimates a tax saving information.

Further, the tax service handling controller 167 generates a tax related document including the generated rental value and the tax saving information. The tax related document includes one or more invoice(s) and a predefined form at an end of a year reflecting income received from a rental event. The predefined form can be, for example, but not limited to, Form 1040, Schedule A for itemizing deductions (e.g., medical expenses, mortgage interest, charitable donations), Schedule B for reporting interest and ordinary dividends, Schedule C for reporting income or loss from a business operated as a sole proprietorship, Schedule D for reporting capital gains and losses, Schedule E for reporting income or loss from rental real estate, royalties, partnerships, S corporations, trusts, etc, Schedule F for reporting profit or loss from farming, Form 1120 used by C corporations to report income, gains, losses, deductions, and credits, Form 1120-S used by S corporations for income reporting, and Form 1065 used by partnerships to report income, deductions, gains, and losses.

Further, the tax service handling controller 167 validates the tax related document. Validating the tax-related document is crucial for ensuring compliance and minimizing the risk of errors or fraud. By carefully reviewing the forms, cross-referencing information, and using available IRS resources, individuals and businesses can confidently manage their tax obligations. In an example, the tax service handling controller 167 ensures that all required fields are completed correctly, including personal information (name, social security number, address) and financial data. In an example, the tax service handling controller 167 confirms that the correct forms are being used for the specific tax year and type of filing (individual, business, etc.).

Further, the tax service handling controller 167 stores and secures the tax related document for an audit purpose. In an example, the tax service handling controller 167 plays a vital role in managing the storage of tax-related documents for the audit purposes. When the user submits the tax document, such as a W-2 or a 1099, the tax service handling controller 167 first validates an incoming data to ensure that all necessary fields are completed accurately, including the user ID, document type, and a secure Uniform Resource Locator (URL) pointing to the stored document. Upon successful validation, the tax service handling controller 167 creates an entry in the database using a predefined model for the tax documents. The predefined model captures essential information, such as the type of document, the URL for easy retrieval, and the timestamp of the upload. For instance, if the user uploads their W-2 form, the tax service handling controller 167 will save the document type as “W-2” along with the URL linking to the file stored on a secure server. Overall, the tax service handling controller 167 serves as a critical component in maintaining accurate tax records, thereby supporting users in fulfilling their tax obligations and preparing for any potential audits.

In an example, the tax service handling controller 167 secures the validated tax related document by using a two-form authentication, a PIN based authentication, a fingerprint-based authentication or the like. Further, the tax service handling controller 167 receives feedback(s) about the validated tax related document and the tax service.

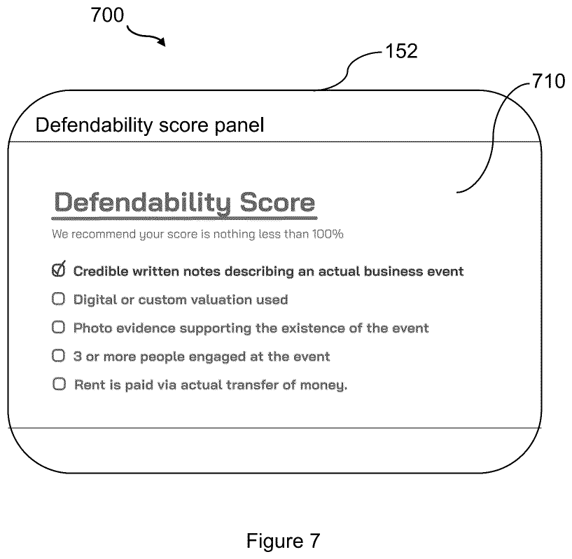

Further, the tax service handling controller 167 generates a property score for the audit purpose. The generation of the property score is explained in FIG. 7. The property score is generated by at least one evidence supporting an existence of the event, the rental information and the feedback from a customer (not shown). The tax service handling controller 167 allows listing of multiple residences per user account.

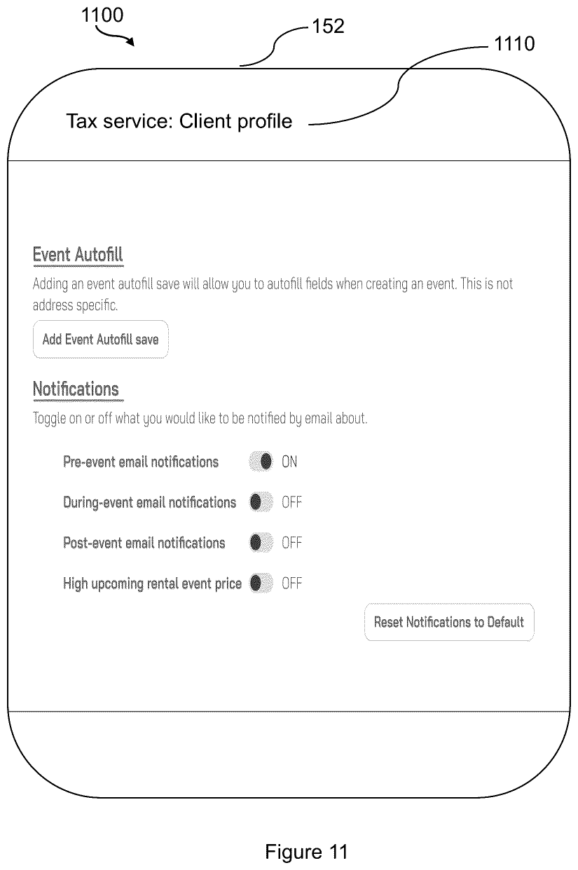

Further, the tax service handling controller 167 sends a reminder and the notification (e.g., email, push notification, short message, or the like) to the user to perform a tax-related action (explained in FIG. 11).

The processor 161 is coupled with the display 152, the storage/memory 163, the communication unit 165, the tax service handling controller 167 and the plurality of user interfaces 112, 122, 132, 142.

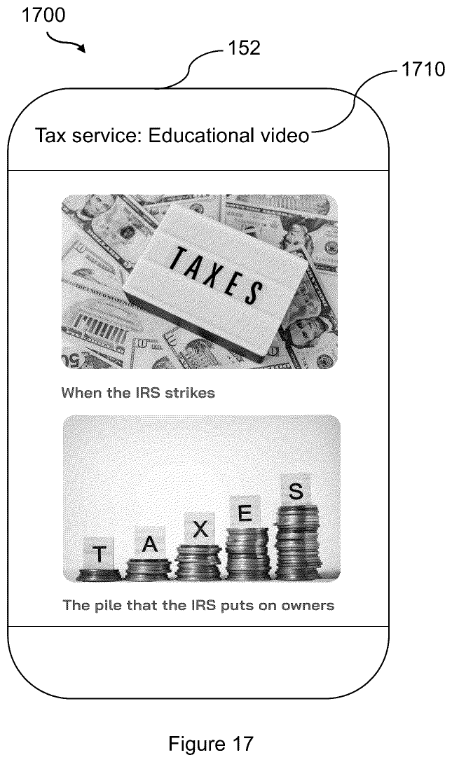

The processor 161 teaches the user about the Augusta Rule and guides the user through a process of maximizing benefits and minimizing liabilities (explained in FIG. 17). The processor 161 may have one or more processors, which may be configured to perform all the processing functionalities of the present invention. The one or more processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU), for example. At least one of aforesaid units/blocks/components may perform their functions by using the processor 161. A function associated with the processor 161 may be performed by utilizing the information stored in the storage/memory 163 like a non-volatile memory, volatile memory, for example and by utilizing the processor 161. The memory 163 includes a database (not shown) that can be, for example, but not limited to a relational database and a non-relational database. The relational database and the non-relational database can be, for example, but not limited to, MySQL, SQL Server database (DB), MariaDB, MongoDB, Oracle Database, PostgreSQL, Informix, Sybase, and IBM Db2. The database can also be, for example, but not limited to, a hierarchical database system, a network database system, an object-oriented database system, an operational database, a graph database, an Amazon Web Services (AWS) Databases, and a cloud database.

Further, the tax savings system 100 may include a communication unit 165 that enables and simplifies communication between all of participants of the system 100 by bringing an instant messaging layer as a central mode of communication between each other.

In an embodiment of the present invention, the tax savings system 100 may have an AI (Artificial Intelligence) unit (not shown) that implements a machine learning method called deep learning. The machine learning method enables the tax savings system 100 to automatically learn and improve from experience, over a period of time, without being explicitly programmed. The deep learning method uses a neural network capable of learning in an unsupervised manner from data that is unstructured or unlabeled. Deep learning is a method of machine learning that employs multiple layers of neural networks that enable the platform of the present invention to teach itself through inference and pattern recognition, rather than development of procedural code or explicitly coded software algorithms (however, machine learning is augmented and enhanced with software algorithms). The neural networks are modeled according to the neuronal structure of a mammal's cerebral cortex, where neurons are represented as nodes and synapses are represented as uniquely weighted paths or “tolled roads” between the nodes. The nodes are then organized into layers to comprise a network. Additionally, the neural networks are organized in a layered fashion that includes an input layer, intermediate or hidden layers, and an output layer.

The neural networks enhance their learning capability by varying the uniquely weighted paths based on received input. The successive layers within the neural network incorporate the learning capability by modifying their weighted coefficients based on their received input patterns. From this foundation, one can see that the training of the neural networks is very similar to how we teach children to recognize an object. The neural network is repetitively trained from a base data set, where results from the output layer (or, simply “output”) are successively compared to the correct classification.

Alternatively, any machine learning paradigm instead of neural networks can be used in the training and learning process. The AI unit supports several different algorithms oriented on the tax service.

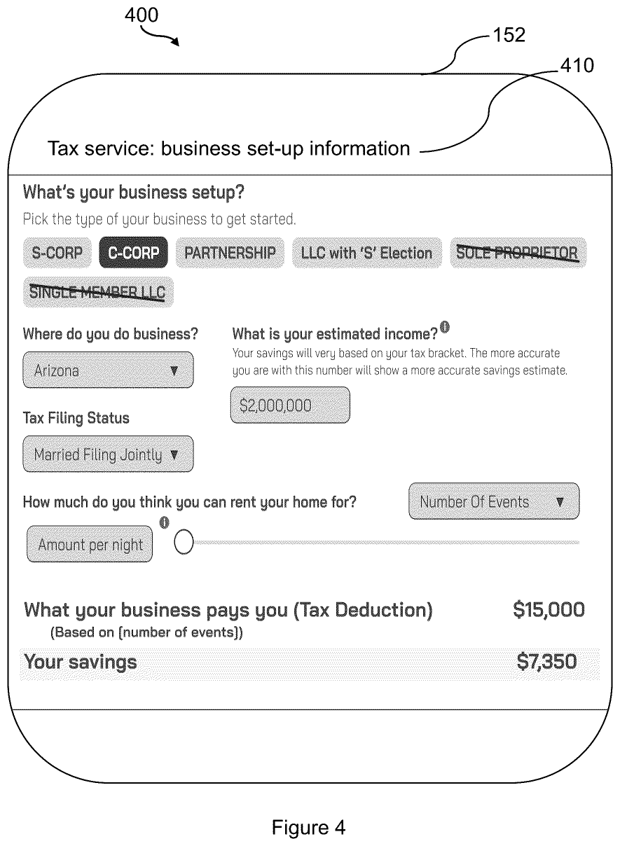

The aforementioned operations of handling the tax service are further explained below in conjunction with FIG. 4 to FIG. 17.

Although FIG. 1 shows various components of the tax savings system 100 but it is to be understood that other embodiments are not limited thereon. The tax savings system 100 may include less or more number of components. Further, the labels or names of the components are used only for illustration purposes and do not limit the scope of the present invention. One or more components can be combined together to perform same or substantially similar function in the tax savings system 100.

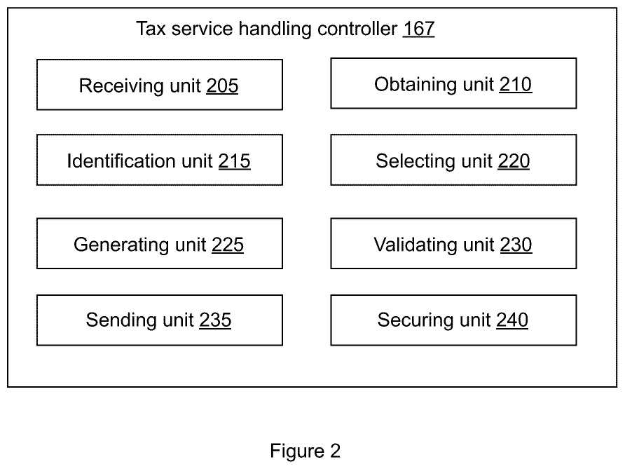

FIG. 2 illustrates various hardware elements of the tax service handling controller 167 of the tax savings system 100. The tax service handling controller 167 has an auto-population feature that streamlines user data entry across forms and documents, significantly reducing the manual input required from the user.

The tax service handling controller 167 includes a receiving unit 205, an obtaining unit 210, an identification unit 215, a selecting unit 220, a generating unit 225, a validating unit 230, a sending unit 235 and a securing unit 240. The receiving unit 205, the obtaining unit 210, the identification unit 215, the selecting unit 220, the generating unit 225, the validating unit 230, the sending unit 235 and the securing unit 240 communicate with each other.

The receiving unit 205, after signing up of the user, receives the user input including the entity type, the rental rate, the number of rental events intended by the user and the tax status, while applying the Augusta Rule for the tax service.

The obtaining unit 210 obtains the database including the rental rate data sourced from the third-party provider. In an implementation, the obtaining unit 210 generates a conservative estimate of rental value for the user's property on a per diem basis, up to six months in advance. The obtaining unit 210 uses algorithmic calculations to provide a benchmark value that the users can adjust while maintaining defensibility according to the IRS guidelines. Also, the obtaining unit 210 obtains the event based on the user input. In an embodiment, the at least one event is obtained by checking the historical data to identify the rent-impact event to determine whether the historical data is the calendar dependent or the event dependent. The historical data is obtained from the third-party provider. In another embodiment, the obtaining unit 210 obtains the date of the future event similar to the impactful historical event. Further, the obtaining unit 210 identifies the traveling event that occur in the location in response to obtaining the date of the future event.

Based on the event, the identification unit 215 identifies and presents the plurality of high priority dates to the user. The selecting unit 220 selects the high priority date from the plurality of high priority dates, to rent the property, by comparing the high priority date among the plurality of high priority dates.

The generating unit 225 generates the rental value for the high priority date based on the predefined rental rate for the property within the user-defined region. The predefined rental rate is computed based on the rental rate data sourced from the third-party provider and the event. Further, the generating unit 225 allows the entry to adjust the generated rental value. The generated rental value estimates the tax saving information. Further, the generating unit 225 generates the tax related document including the generated rental value and the tax saving information. In an implementation, the generating unit 225 projects the user's potential savings based on several inputs, including the entity type, a tax filing status, and the number of rental events intended by the user. The generating unit 225 is designed to work with various tax structures and entity types across different states. The generating unit 225 also generates the property score for the audit purpose. The property score is generated by using the evidence supporting the existence of the event, the rental information and the feedback from the customer.

The validating unit 230 validates and stores the tax related document for the audit purpose.

The sending unit 235 sends the reminder(s) and the notification(s) to the user to perform the tax-related action. The sending unit 235 sends automated reminders for the tax-related actions and allows the users to forward all necessary tax information to their Certified Public Accountant (CPA) directly from the tax savings system 100.

The securing unit 240 secures the validated tax related document in the event of the audit. In other words, the securing unit 240 offers an add-on service, which provides an additional layer of security by offering to defend the user's claimed rental valuation in the event of the IRS audit. The securing unit 240 has document generation and management capabilities, including the use of DocuSign for secure ratification of the documents, and the ability to store and manage critical legal documents produced by tax attorneys.

Although FIG. 2 shows various components of the tax service handling controller 167 but it is to be understood that other embodiments are not limited thereon. The tax service handling controller 167 may include less or more number of components. Further, the labels or names of the components are used only for illustration purposes and do not limit the scope of the present invention. One or more components can be combined together to perform same or substantially similar function in the tax service handling controller 167.

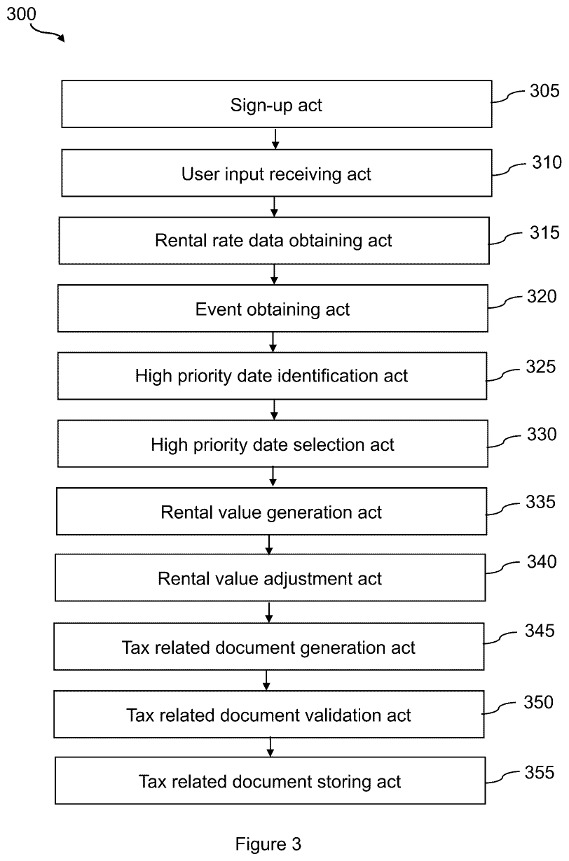

FIG. 3 illustrates a flow chart 300 of a method for handling the tax service.

In a sign-up act 305, the user (e.g., client 130) signups on the electronic device 150 (i.e., on a platform providing tax handling services). During the signup, the user provides the name, the address, the location information, the property type, the previous user feedback (e.g., feedback related to issues with implementing the Augusta Rule in the past), and the contact details.

After signup, in a user input receiving act 310, the tax service handling controller 167 receives the user input including the entity type, the rental rate, the number of rental events intended by the user and the tax status, while applying the Augusta Rule for the tax service.

Next, in a rental rate data obtaining act 315, the tax service handling controller 167 obtains the database having the rental rate data sourced from the third-party provider.

In an event obtaining act 320, the tax service handling controller 167 obtains the event based on the user input. The event can be, for example, but not limited to, the calendar event, the historical event, the sports event, the government related event, the musical event, the movie related event, and the traveling event.

In a high priority date identification act 325, the tax service handling controller 167 identifies and presents the plurality of high priority dates to the user based on the event.

In a high priority date selection act 330, the tax service handling controller 167 selects the high priority date from the plurality of high priority dates to rent the property by comparing the high priority date among the plurality of high priority dates.

In a rental value generation act 335, the tax service handling controller 167 generates the rental value for the high priority date based on the predefined rental rate for the property within the user-defined region. The rental value is generated in accordance with the IRS guideline. The predefined rental rate is computed based on the rental rate data sourced from the third-party provider and the event. The predefined rental rate is determined by at least one of: the user, the service provider and the government agency.

In a rental value adjustment act 340, the tax service handling controller 167 allows the entry to adjust the generated rental value by obtaining the date of the future event, the feedback and the notification about the date of the future event from the third-party provider. The generated rental value estimates the tax saving information.

In a tax related document generation act 345, the tax service handling controller 167 generates the tax related document including the generated rental value and the tax saving information. The tax related document includes the invoice and the predefined form at an end of a year reflecting income received from the rental event.

In a tax related document validation act 350, the tax service handling controller 167 validates the tax related document.

Next, in a tax related document storing act 355, the tax service handling controller 167 stores the tax related document for audit purpose.

FIG. 4 is an example screenshot 400 showing a business set-up information panel 410, where the user can provide relevant information to put their property for renting purposes. The business setup information includes the type of the business (e.g., S-Corp, C-Corp, Partnership, LLC with “S” election, sole proprietorship, single-member LLC, or similar), the location of the business, estimated income, tax filing status, rental information about the property (e.g., home, building, residence, or similar), tax deduction information, and tax savings information.

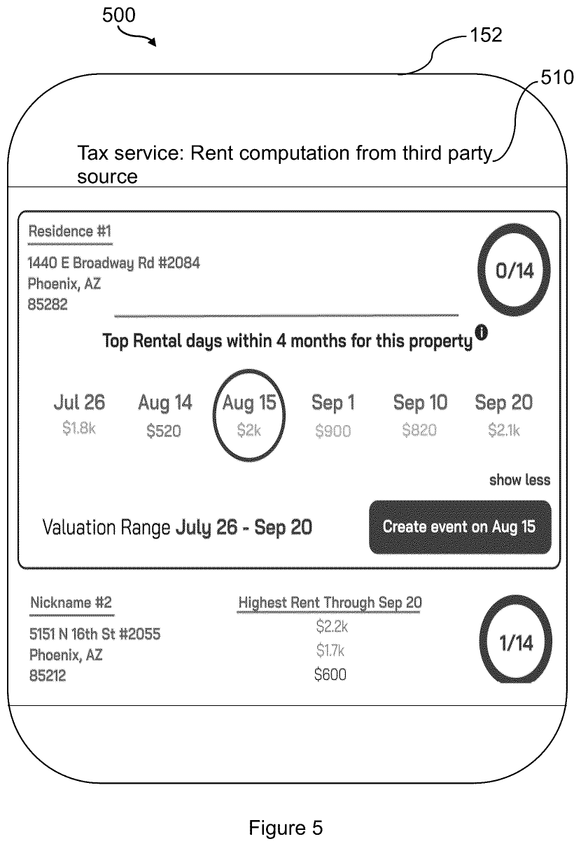

FIG. 5 is an example screenshot 500 showing rent computation from the third-party source. The electronic device 150 displays the rent computation from the third-party source in a rent determination panel 510. The rent determination panel 510 is showcasing the top rental days (i.e., dates having highest rents) for a four-month period from July 26 to September 20, for example, with the rental data fetched from sources such as Airbnb®, Vacasa or the like. For instance, the rent for July 26 is $1,800, the rent for August 14 is $520, the rent for August 15 is $2,000, the rent for September 1 is $900, the rent for September 10 is $820, and the rent for September 20 is $2,100.

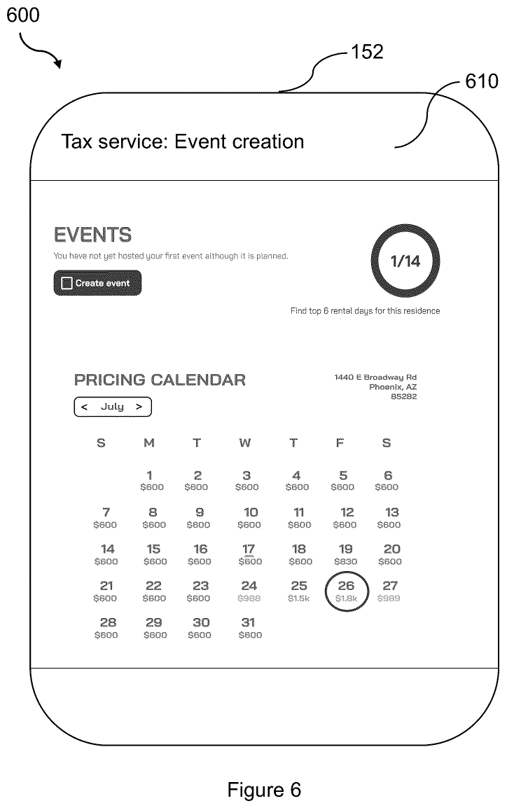

FIG. 6 is an example screenshot 600 displaying a rental event creation in a rental event creation panel 610. The rental event creation panel 610 displays a pricing calendar for a month after the user signs up in the electronic device 150.

FIG. 7 is an example screenshot 700 showing a defendability score. The electronic device 150 generates the defendability score (i.e., property score or the like) for the audit purpose in a defendability score panel 710. The property score is generated by at least one of: at least one evidence supporting an existence of the event, the rental information, the feedback from the customer, the rent paid via actual transfer of money, and a number of people engaged at the event.

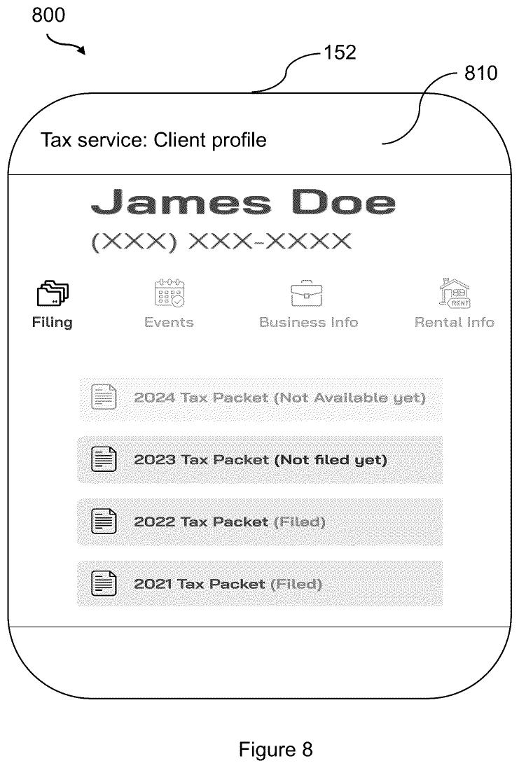

FIG. 8 is an example screenshot 800 of a client profile. The electronic device 152 displays the client profile in a client profile panel 810. The client profile panel 810 shows the tax filing status for various years, event information for different years, business information, and rental information.

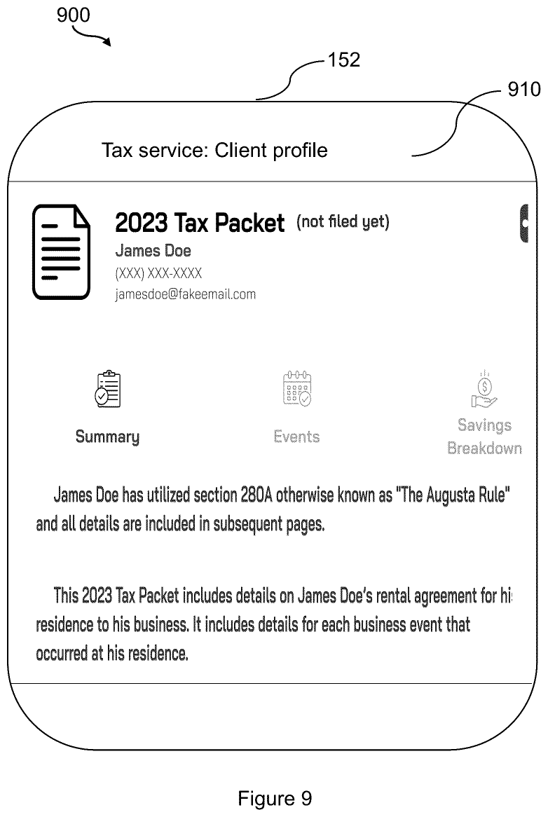

FIG. 9 is an example screenshot 900 showing a summary of the client profile, for a particular year, in a client profile panel 910. The client profile panel 910 shows the client's usage of the Augusta rule (i.e., Section 280A), a rental agreement for his residence to his business, and details of each business event that occurred at the residence.

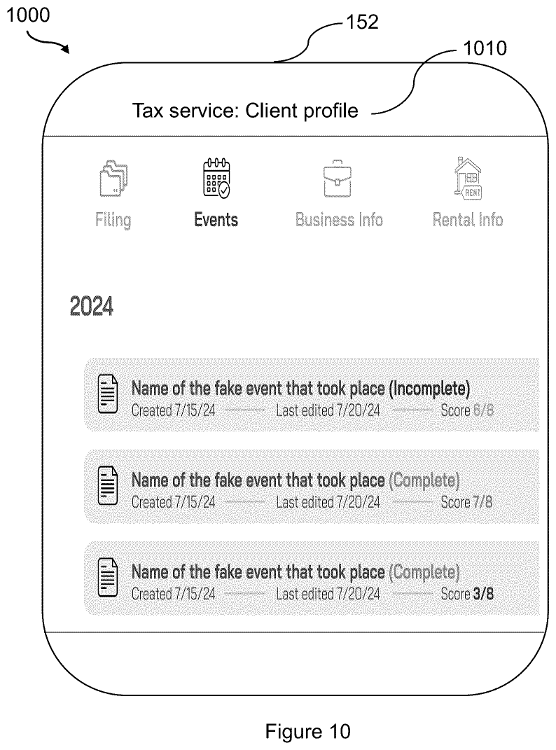

FIG. 10 is an example screenshot 1000 showing events associated with the client profile. Various events are created and displayed in a client profile panel 1010, in which two events are completed and one event is yet to be completed.

FIG. 11 is an example screenshot 1100 of a client profile setting panel 1110. The electronic device 150 displays event autofill information and notification details (e.g., pre-event email notifications, during-event email notifications, post-event email notifications, high upcoming rental event price email notifications, or similar) in the client profile settings panel 1110.

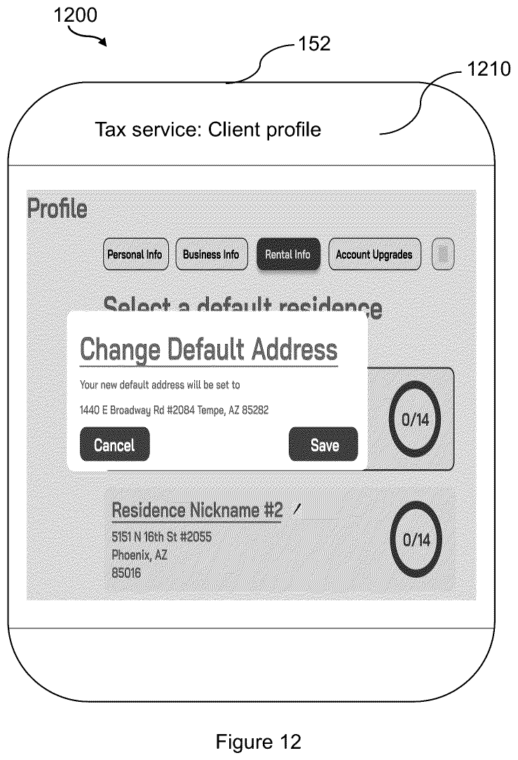

FIG. 12 is an example screenshot 1200 for updating profile information such as rental information and address information associated with the client profile.

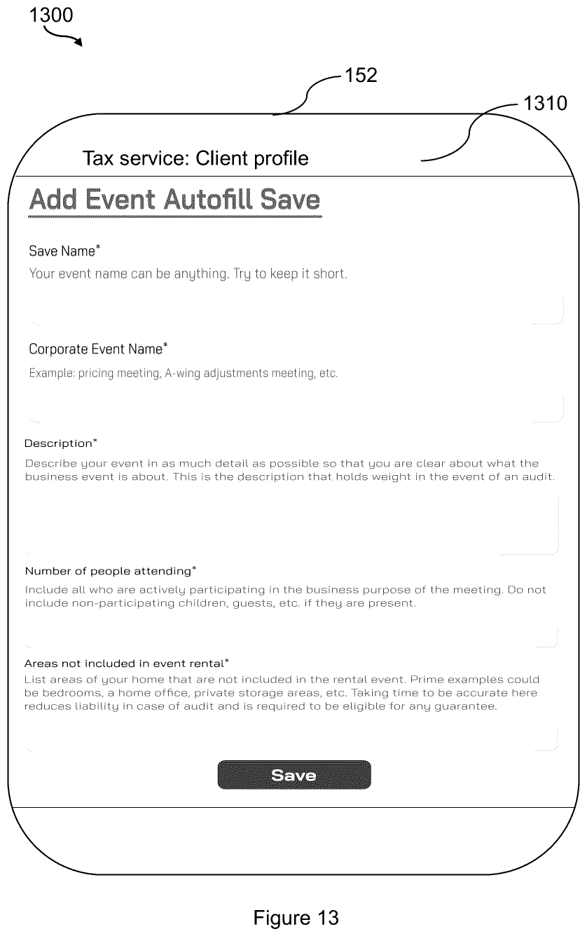

FIG. 13 is an example screenshot 1300 of an event filing panel 1310. The event filing panel 1310 allows the user to add the business event name, a description of the business event, the number of people attending the business event, and areas (e.g., bedroom, kitchen, or similar) not included in the rental for the business event.

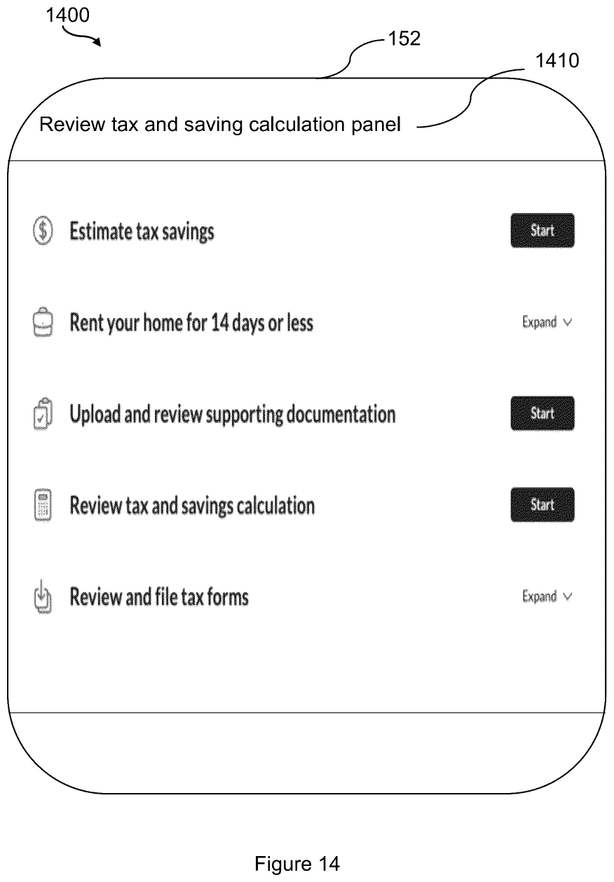

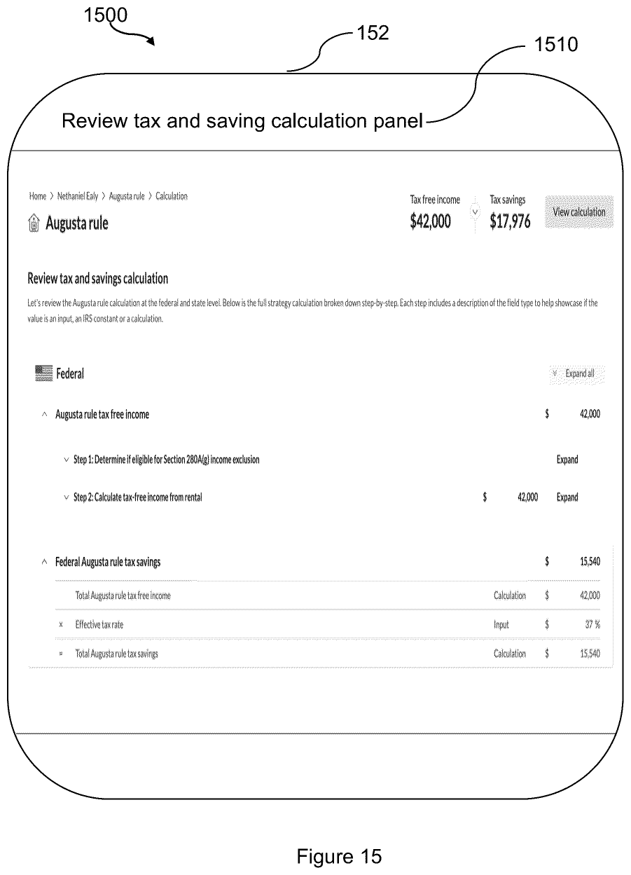

FIG. 14 is an example screenshot 1400 of a review tax and saving calculation panel 1410. The review tax and savings calculation panel 1410 provides an overview of various fields (e.g., estimated tax savings, renting your home for 14 days or less, uploading and reviewing supporting documents, reviewing tax and savings calculations (as shown in FIG. 15), and reviewing and filing tax forms, or similar).

FIG. 15 is an example screenshot 1500 of a review tax and saving calculation panel 1510 in conjunction with FIG. 14. The review tax and savings calculation panel 1510 allows the user to review the Augusta rule calculation at both the federal and state levels. The review tax and savings calculation panel 1510 presents the full strategy calculation in a step-by-step manner. Each step includes a description of the field type to indicate whether a data value is an input, an IRS constant, or a calculation.

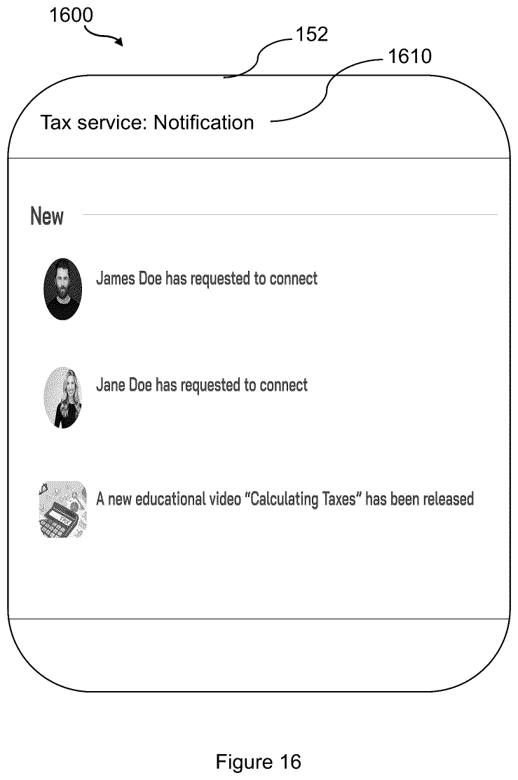

FIG. 16 is an example screenshot 1600 displaying tax service-related notification in a tax service-related notification panel 1610. The tax service-related notification can be, for example, but not limited to a connection request related notification, a demo related notification, news event related notification.

FIG. 17 is an example screenshot 1700 displaying tax service-related educational videos 1710. The educational videos teach the user about the Augusta Rule and guides the user through a process of maximizing benefits and minimizing liabilities.

The aforementioned fields shown in FIGS. 4 to 17 are example fields to be used in the system 100. The system 100 may use more or less fields as per implementation. Also, it may be noted that FIGS. 1 and 2 are to be understood in conjunction with FIG. 3 to FIG. 17.

The various actions, acts, blocks, steps, or the like in the flow diagrams may be performed in the order presented, in a different order or simultaneously. Further, in some embodiments, some of the actions, acts, blocks, steps, or the like may be omitted, added, modified, skipped, or the like without departing from the scope of the present invention.

Unless otherwise defined, all technical and scientific terms used herein have the same meaning as commonly understood by one of ordinary skill in the art to which this invention belongs. Although methods and materials similar to or equivalent to those described herein can be used in the practice or testing of equivalent systems and methods, suitable systems and methods and are described above. Although the invention has been described and illustrated with specific illustrative embodiments, it is not intended that the invention be limited to those illustrative embodiments. Those skilled in the art will recognize that variations and modifications can be made without departing from the spirit of the invention. Therefore, it is intended to include within the invention, all such variations and departures that fall within the scope of the appended claims and equivalents thereof.

What is claimed is:

1. A method for handling a tax service, comprising:
signing up, by a user, on an electronic device;
receiving, by the electronic device, a user input comprising at least one entity type, at least one rental rate, a number of rental events intended by the user and at least one tax status, while applying an Augusta Rule for the tax service, wherein the user input is received after the signup by the user;
obtaining, by the electronic device, at least one database comprising a rental rate data sourced from a third-party provider;
obtaining, by the electronic device, at least one event based on the user input;
identifying and presenting, by the electronic device, a plurality of high priority dates to the user based on the at least one event;
selecting, by the electronic device, at least one high priority date from the plurality of high priority dates to rent a property by comparing the at least one high priority date among the plurality of high priority dates;
generating, by the electronic device, at least one rental value for at least one high priority date based on a predefined rental rate for the property within a user-defined region, wherein the predefined rental rate is computed based on the rental rate data sourced from the third-party provider and the at least one event;
allowing, by the electronic device, an entry to adjust the at least one generated rental value, wherein the at least one generated rental value estimates a tax saving information;
generating, by the electronic device, a tax related document comprising the at least one generated rental value and the tax saving information;
validating, by the electronic device, the tax related document; and
storing, by the electronic device, the tax related document for at least one audit purpose.

2. The method of claim 1, wherein the method comprises:
generating, by the electronic device, a property score for the at least one audit purpose, wherein the property score is generated by: at least one of: at least one evidence supporting an existence of the at least one event, rental information and a feedback from a customer.

3. The method of claim 1, wherein the at least one event is obtained by checking a historical data to identify a rent-impact event to determine whether the historical data is calendar dependent or event dependent, wherein the historical data is obtained from the third-party provider.

4. The method of claim 1, wherein obtaining, by the electronic device, the at least one event comprises:
obtaining, by the electronic device, a date of at least one future event similar to an impactful historical event; and
identifying, by the electronic device, a traveling event that occur in at least one location in response to obtaining the date of the at least one future event.

5. The method of claim 4, wherein the method further comprises presenting, by the electronic device, an estimated future residential rental value as a function of the impact that the traveling event having at least one historical geography.

6. The method of claim 1, wherein allowing, by the electronic device, the entry to adjust the at least one generated rental value comprises:
obtaining, by the electronic device, at least one date of at least one future event;
obtaining, by the electronic device, at least one of: a feedback and a notification about the at least one date of the at least one future event from the third-party provider; and
allowing, by the electronic device, the entry to adjust the at least one generated rental value based on at least one of: the feedback and the notification.

7. The method of claim 1, wherein the at least one event comprises at least one of: a calendar event, a historical event, a sports event, a government related event, a musical event, a movie related event, and a traveling event, wherein the predefined rental rate is determined by at least one of: the user, a service provider and a government agency, wherein the tax related document comprises at least one invoice and a predefined form at an end of a year reflecting income received from at least one rental event, wherein the at least one rental value is generated in accordance with an Internal Revenue Service (IRS) guideline, and wherein during the signup, the user provides at least one of: a name, an address, a location information, a property type, a previous user feedback, and contact details.

8. The method of claim 1, wherein the method comprises sending, by the electronic device, at least one of: a reminder and a notification to the user to perform at least one tax-related action.

9. The method of claim 1, wherein the method comprises securing, by the electronic device, the validated tax related document in an event of the at least one audit purpose.

10. The method of claim 1, wherein the method comprises receiving, by the electronic device, a feedback about at least one of: the validated tax related document and the tax service.

11. The method of claim 1, wherein the electronic device teaches the user about the Augusta Rule and guide the user through a process of maximizing benefits and minimizing liabilities, wherein the electronic device allows multiple residences per account of the user.

12. An electronic device for handling a tax service, comprising:
a memory; and
a processor, coupled with the memory, configured to:
signup a user on the electronic device;
receive a user input comprising at least one entity type, at least one rental rate, a number of rental events intended by the user and at least one tax status, while applying an Augusta Rule for the tax service, wherein the user input is received after the signup by the user;
obtain at least one database comprising a rental rate data sourced from a third-party provider;
obtain at least one event based on the user input;
identify and present a plurality of high priority dates to the user based on the at least one event;
select at least one high priority date from the plurality of high priority dates to rent a property by comparing the at least one high priority date among the plurality of high priority dates;
generate at least one rental value for at least one high priority date based on a predefined rental rate for the property within a user-defined region, wherein the predefined rental rate is computed based on the rental rate data sourced from the third-party provider and the at least one event;
allow an entry to adjust the at least one generated rental value, wherein the at least one generated rental value estimates a tax saving information;
generate a tax related document comprising the at least one generated rental value and the tax saving information;
validate the tax related document; and
store the tax related document for at least one audit purpose.

13. The electronic device of claim 12, wherein the processor is configured to:
generate a property score for the at least one audit purpose, wherein the property score is generated by: at least one of: at least one evidence supporting an existence of the at least one event, rental information and a feedback from a customer.

14. The electronic device of claim 12, wherein the at least one event is obtained by checking a historical data to identify a rent-impact event to determine whether the historical data is calendar dependent or event dependent, wherein the historical data is obtained from the third-party provider.

15. The electronic device of claim 12, wherein obtain the at least one event comprises:
obtain a date of at least one future event similar to an impactful historical event; and
identify a traveling event that occur in at least one location in response to obtaining the date of the at least one future event.

16. The electronic device of claim 15, wherein the processor is configured to present an estimated future residential rental value as a function of the impact that the traveling event having at least one historical geography.

17. The electronic device of claim 12, wherein allow the entry to adjust the at least one generated rental value comprises:
obtain at least one date of at least one future event;
obtain at least one of: a feedback and a notification about the at least one date of the at least one future event from the third-party provider; and
allow the entry to adjust the at least one generated rental value based on at least one of: the feedback and the notification.

18. The electronic device of claim 12, wherein the at least one event comprises at least one of: a calendar event, a historical event, a sports event, a government related event, a musical event, a movie related event, and a traveling event, wherein the predefined rental rate is determined by at least one of: the user, a service provider and a government agency, wherein the tax related document comprises at least one invoice and a predefined form at an end of a year reflecting income received from at least one rental event, wherein the at least one rental value is generated in accordance with an Internal Revenue Service (IRS) guideline, and wherein during the signup, the user provides at least one of: a name, an address, a location information, a property type, a previous user feedback, and contact details.

19. The electronic device of claim 12, wherein the processor is configured to send at least one of: a reminder and a notification to the user to perform at least one tax-related action, and wherein the processor is configured to secure the validated tax related document in an event of the at least one audit purpose, wherein the processor is configured to receive a feedback about at least one of: the validated tax related document and the tax service.

20. The electronic device of claim 12, wherein the processor is configured to teach the user about the Augusta Rule and guide the user through a process of maximizing benefits and minimizing liabilities, wherein the electronic device allows multiple residences per account of the user.
